(19) United States
(12) Patent Application Publication
(10) Pub. No.: US 2010/0127035 A1
(43) Pub. Date: May 27, 2010

(54) Braking Mechanism for Nail Guns

(76) Inventor: I-Tsung WU, Taipei Hsien (TW)

Correspondence Address: HDLS Patent & Trademark Services, P.O. BOX 220746, CHANTILLY, VA, 20153-0746, US

(21) Appl. No.: 12/323,464

(22) Filed: Nov. 25, 2008

(51) Int. Cl. B25C 5/16

(52) U.S. Cl. 227/125; 227/8

(57) ABSTRACT

In a braking mechanism for a nail gun, the nail gun includes a nail driving track, a magazine and an inner trigger for controlling a shooting action of the nail gun. The braking mechanism includes a safety rod, a sliding member, a swing stem, and a guide plate. The sliding member is slidably received in the magazine. The sliding member is configured for pushing nails received in the magazine into the nail driving track. The swing stem is resiliently and pivotally mounted on the sliding member. The swing stem includes a braking portion. A straight path is defined between the safety rod and the barking portion. A protrusion is formed on the braking portion. The guide plate is disposed at an end of the straight path. The guide plate is configured for guiding the protrusion such that the braking portion moves away from the straight path. The swing stem is capable of sliding off the guide plate as the sliding member moves to the nail driving track such that the braking portion moves back to the straight path to block the safety rod thereby braking shooting action of the nail gun. The braking mechanism has improved stability of braking of shooting action.

### BACKGROUND

The present invention relates to braking mechanisms, and particularly relates to a braking mechanism for a nail gun.

Generally, braking mechanisms are used in nail guns to automatically detect whether there are adequate nails in magazines and brake the shooting action of nail guns if there is no nail in the magazine. Usually, the braking mechanism disable the trigger valve of nail guns thereby reminding of the operator to reload nails.

For example, Taiwan patent No. 321044 discloses such a braking mechanism for a nail gun, in which a sliding member is employed to push nails into nail driving track. A braking member is formed on a side of the sliding member. The sliding member is opposite to a safety rod of the nail gun. The braking member moves to the safety rod together with the sliding member at a displacement of a thickness of the nail when a nail is shot out of the nail gun. To ensure that the safety rod can move freely in upward and downward direction when there is only one nail in the nail track, a distance between the braking member and the safety rod should be equal to a distance between the sliding member and the nail driving track. As such, the sliding member enters into the nail driving track when the last nail is shot out of the nail gun, and the braking member moves to a position at which the braking member is capable of blocking the safety rod such that the safety rod can't move upwardly. As a result, the nail gun is braked. The operator needs to reload nails into the nail track. Generally, fine nails are popularly used in nail guns, for example, mosquito nails which have thickness of about 1.2 millimeters.

However, the braking member can merely move at a distance equals to the thickness of the last nail (e.g. about 1.2 millimeters) after the last nail is shot out of the nail gun. In other words, the braking member blocks the safety rod using an area having a width that is equal to about 1.2 millimeters. In such conditions, if the operator presses the trigger forcedly the safety rod may slide off the braking member. As a result, the braking mechanism fails to brakes the shooting action.

Therefore, there is a desire to improve a stability of barking of shooting action.

### BRIEF SUMMARY

To overcome aforementioned problems, an object of the present invention is to provide a braking mechanism for a nail gun, and particularly to provide a braking mechanism in which: a braking portion is capable of moving along a curved path to a position at which the braking portion can prevent the safety rod from moving upwardly under improved contact area. As such, a stability of braking of shooting action is also improved.

In one embodiment, a braking mechanism for a nail gun is provided. The nail gun includes a nail driving track, a magazine and an inner trigger for controlling a shooting action of the nail gun. The braking mechanism includes a safety rod, a sliding member, a swing stem, and a guide plate. The sliding member is slidably received in the magazine. The sliding member is configured for pushing nails received in the magazine into the nail driving track. The swing stem is resiliently and pivotally mounted on the sliding member. The swing stem includes a braking portion. A straight path is defined between the safety rod and the barking portion. A protrusion is formed on the braking portion. The guide plate is disposed at an end of the straight path. The guide plate is configured for guiding the protrusion such that the braking portion moves away from the straight path. The swing stem is capable of sliding off the guide plate as the sliding member moves to the nail driving track such that the braking portion moves back to the straight path to block the safety rod thereby braking shooting action of the nail gun.

The present braking mechanism for a nail gun will be described in detail with reference to figures together as following:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded perspective view of a braking mechanism for nail guns in accordance with an embodiment;

FIG. 2 is a cross sectional view of the braking mechanism of FIG. 1;

FIG. 3 is another cross sectional view of the braking mechanism of FIG. 1;

FIG. 3a is an partially enlarged view of the FIG. 3;

FIG. 4 is a schematic view showing an operation state of the braking mechanism of FIG. 1;

FIG. 5 is a schematic view showing an operation state of a guide plate and a swing stem in the braking mechanism of FIG. 1;

FIG. 6 is another schematic view showing an operation state of the braking mechanism of FIG. 1; and

FIGS. 7a to 7g are schematic view showing successive operating state of the braking mechanism of FIG. 1.

### DETAILED DESCRIPTION

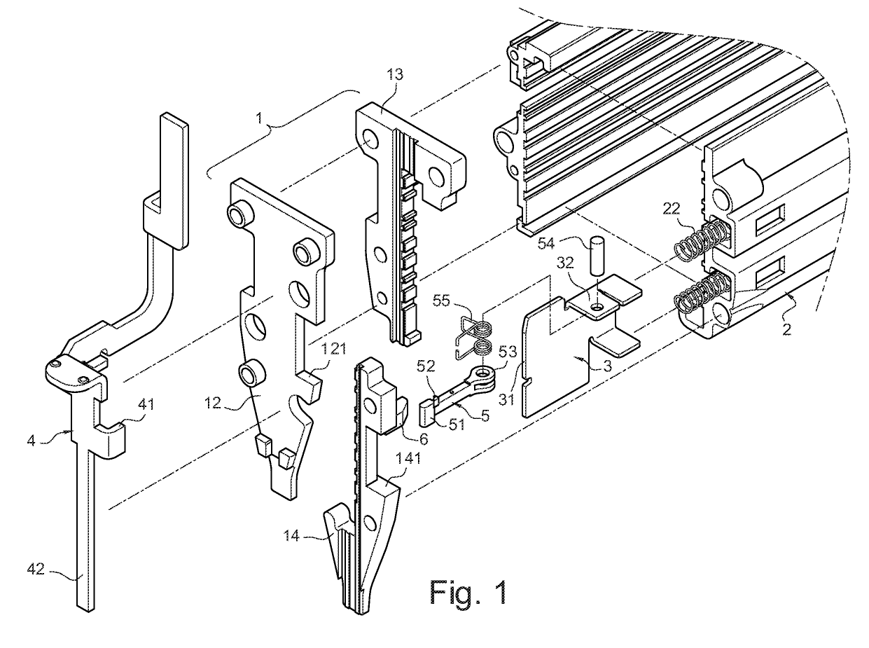

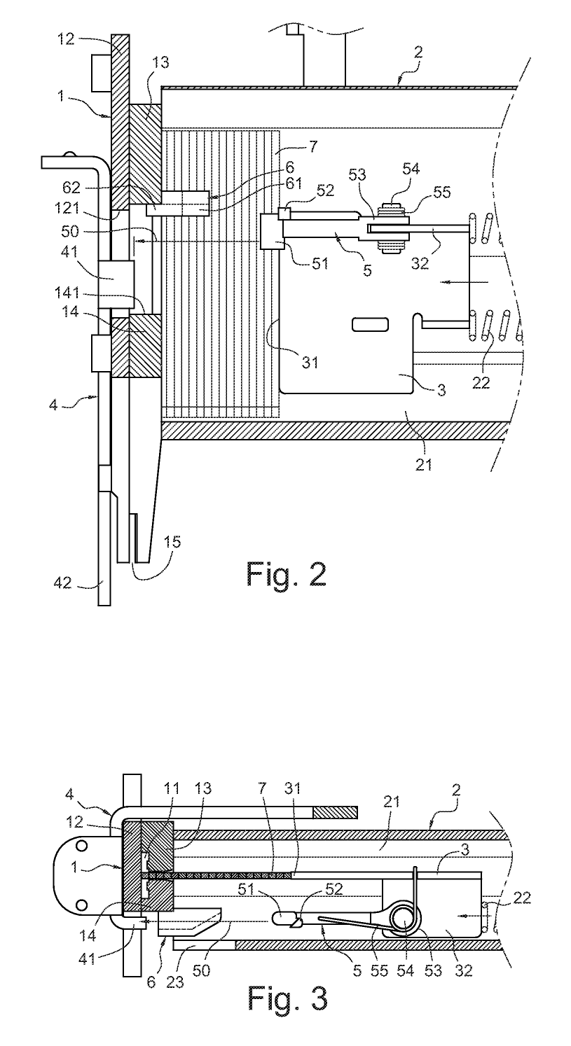

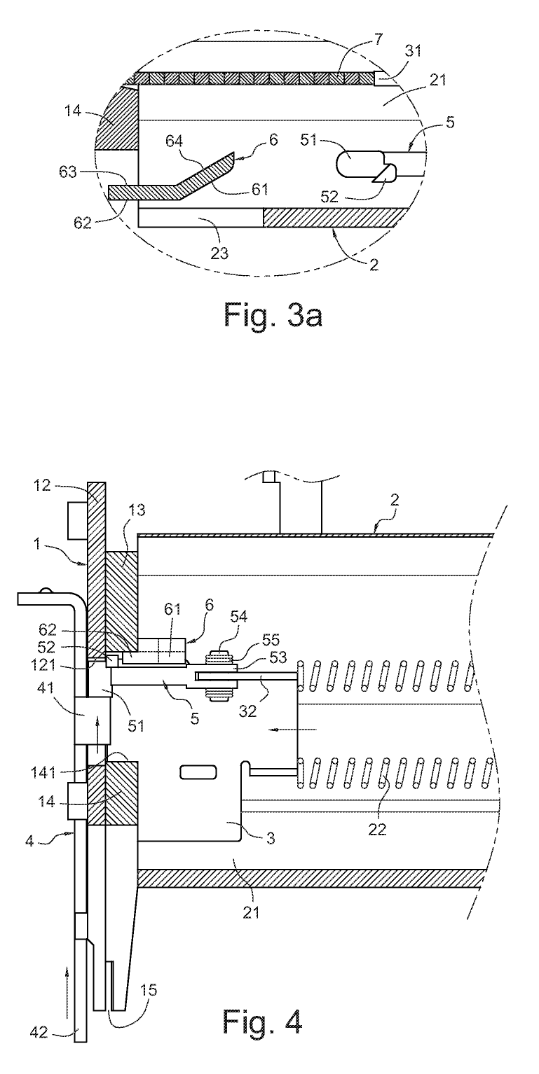

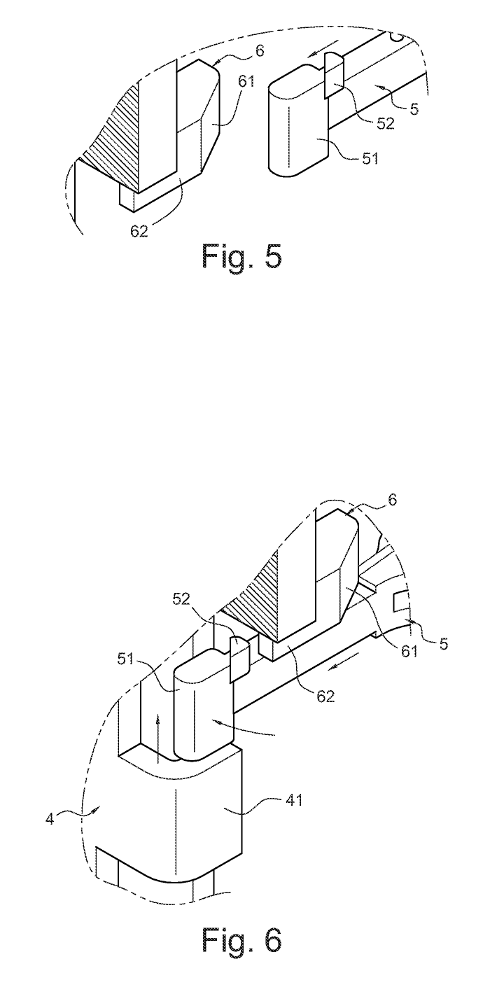

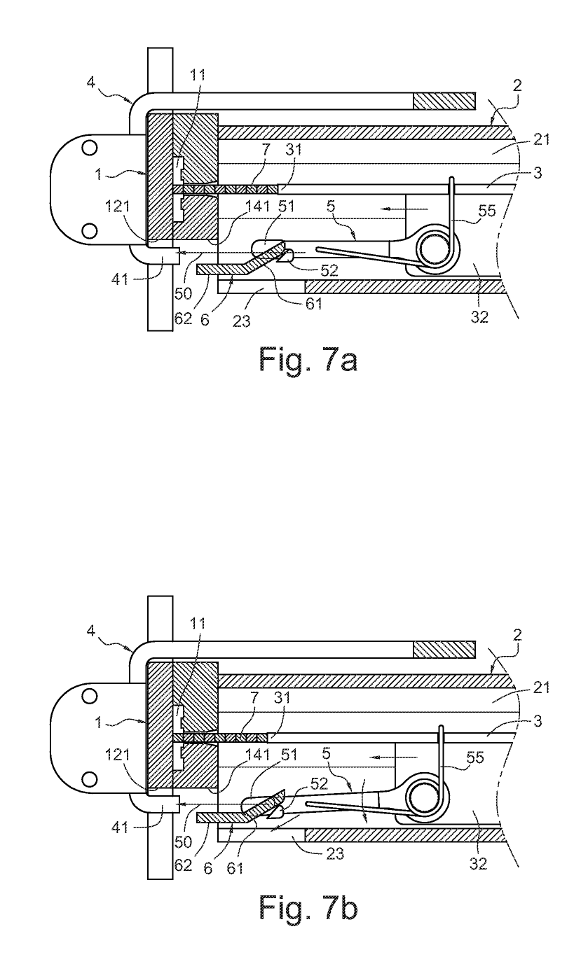

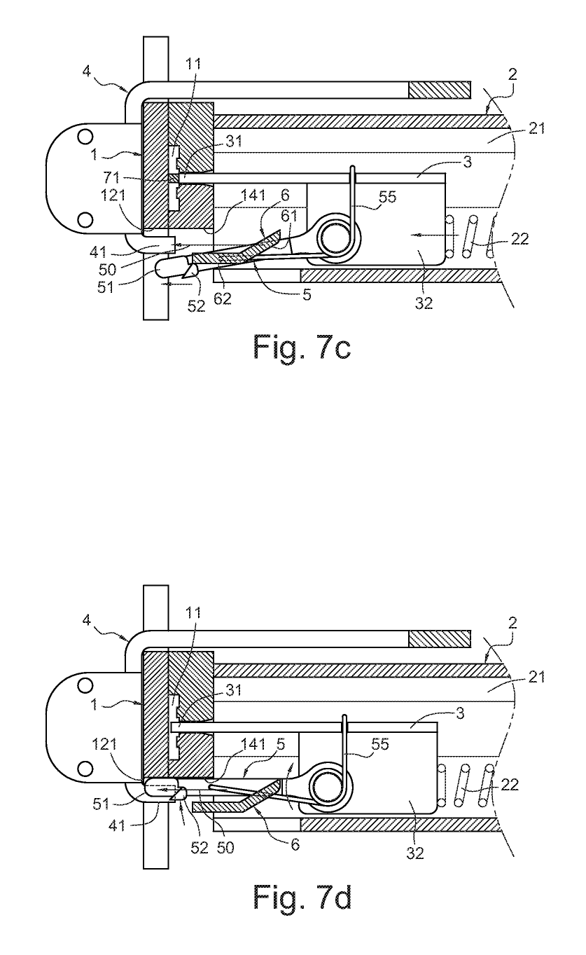

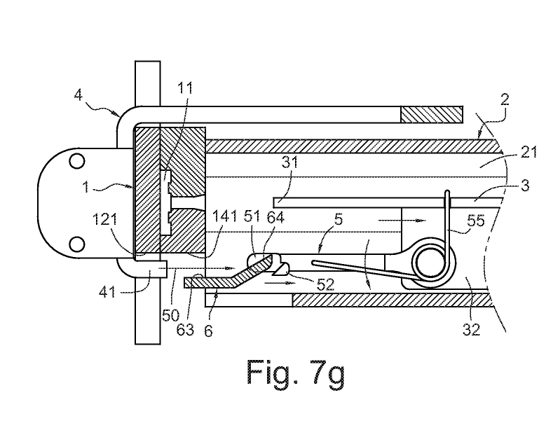

FIG. 1 illustrates an exploded perspective view of a braking mechanism for a nail gun in accordance with a first embodiment. The nail gun includes a magazine 2. Referring together with FIGS. 2 and 3, the magazine 2 is disposed at an end side of the nail track base 1. The nail track base 1 defines a nail driving track 11, which is in communication with the magazine 2. The braking mechanism includes a safety rod 4, a sliding member 3, a swing stem 5 and a slope guide plate 6. The sliding member 3 is slidably received in the magazine 2. The sliding member 3 extends to the nail driving track 11 and forms a pressing portion 31 at an end thereof. The pressing portion 31 is configured for pressing the nails 7 into the nail driving track 11. The safety rod 4 is slidably disposed on the nail track base 1. The swing stem 5 is pivotably mounted on an end side of the sliding member 3. The swing stem 5 moves together with the sliding member 3. In addition, the swing stem 5 extends to the nail track and form a braking portion 51 (as shown in FIG. 5). A straight path 50 is formed between the safety rod 4 and the braking portion 50. The swing stem 5 further includes a protrusion 52 formed on a surface of the braking portion 51. The guide plate 6 is located at an end of the straight path 50 and is adjacent to the nail track base 1. The guide plate 6 is configured for guiding the protrusion 52 (as shown in FIGS. 7a and 7b) of the swing stem 5 so as to lead the swing stem 5 away from the straight path 50. The swing stem 5 can moves to the nail track base 1 together with the sliding member 3 till the protrusion 52 falls off the guide plate 6 (as shown in FIGS. 4, 6 and 7d). In the present embodiment, the protrusion 52 falls off the guide plate 6 after the pressing portion 31 of the sliding member 3 pushes last nail 71 in the magazine 2 into the nail driving track 11. As such, the braking portion 51 moves back to the straight path 50 and block the safety rod 4 to move upwardly. The safety rod 4 drives the inner trigger in the nail gun to swing thereby driving the valve stem of a trigger valve to open the trigger valve when the safety rod 4 moves upwardly to a predetermined position. As such, the nail gun starts to shoot nails 7.

In the present embodiment, the nail 7 is a relative thin nail. However, it is to be understood that the nail 7 is not limited to fine nail. In other words, the nail 7 can be also thick nail.

The nail track base 1 includes an upper guide plate 12, a first lower guide plate 13 and a second lower guide plate 14 (as shown in FIGS. 1 and 3). The nail driving track 11 is formed between the upper guide plate 12 and the first, second lower guide plates 13, 14. Two end grooves 121, 141 are respectively formed in the upper guide plate 12 and the second lower guide plate 14. The end grooves 121, 141 are opposite to the braking portion 51 and are parallel to the nail driving track 11. The safety rod 4 is slidably mounted at a side of the upper guide plate 12. The safety rod 4 includes an ear portion 41 extends into the end grooves 121, 141. An end of the safety rod 4 extends to a position at which the safety rod is capable of pressing the inner trigger of the trigger thereby driving the valve stem in the trigger valve to open the trigger valve. The safety rod 4 also includes a positioning member 42 extends exceeding a nail exit 15 of the nail driving track 11. The positioning member 42 is configured for pressing on a surface of a workpiece such that the safety rod 4 moves upwardly or downwardly. As such, the ear portion 41 also moves in the end grooves 121, 141 upwardly or downwardly.

A distance between the braking portion 51 and the ear portion 41 of the safety rod 4 (as shown in FIG. 3) is less than a distance between the pressing portion 31 of the sliding member 3 and the inner sidewall of the nail driving track 11. In the present embodiment, a length of the braking portion 51 is greater than that of the pressing portion 31 about thickness of two nails 7.

The magazine 2 is connected to an open end of the nail driving track 11 (as shown in FIGS. 1 through 3). In addition, the magazine 2 includes a nail track 21 that is in communication with the nail driving track 11. The magazine 2 is configured for receiving a number of nails 7 therein. The sliding member 3 is slidably received in the nail track 21. At least one spring is disposed between the sliding member 3 and an inner sidewall of the nail track 21. In the present embodiment, there are two springs 22 or the like employed in the nail gun. The springs 22 are capable of driving the sliding member 3 to move to the nail track base 1 such that the sliding member 3 pushes the nails 7 to enter into the nail driving track 11. The swing stem 5, the braking portion 51 and the protrusion 52 moves to the nail track base 1 together with the sliding member 3. A cutaway portion 23 is formed in the magazine 2. The cutaway portion 23 is adjacent to the guide plate 6 and connects the nail track 21 to the outer space. The braking portion 51 can pass through the cutaway portion 23 when the guide plate 6 guides the protrusion 52 (as shown in FIGS. 7b and 7c).

A pivot seat 32 (as shown in FIGS. 1 and 3) is formed on a side of the sliding member 3. The swing stem 5 includes a pivot portion 53 opposite to the braking portion 51 and the protrusion 52. The pivot portion 53 is pivotably mounted on the pivot seat 32 using a shaft 54. In addition, a torque spring 55 is telescopically disposed around the shaft 54, and two ends of the torque spring 55 are fixed to the sliding member 3 and the swing stem 5 respectively such that the swing stem 5 is resiliently and pivotably disposed on the end side of the sliding member 3.

The guide plate 6 is at an end side of the nail track base 1 (as shown in FIGS. 1 and 3). The guide plate 6 includes an outer slope surface 61 and an inner slope surface 64 (as shown in FIG. 3a). The braking portion 51 is opposite to the outer slope surface 61 when received in the nail track 21. The braking portion 51 is opposite to the inner slop surface 64 when the braking portion 51 is capable of blocking the safety rod 4 (as shown in FIG. 7d). An outer plain surface 62 (as shown in FIG. 5) extends from the outer slope surface 61 in a direction that is parallel to the straight path 50, and an inner plain surface 63 extends from the inner slope surface 64 in a direction that is parallel to the straight path 50. The outer slope surface 61 is configured for guiding the protrusion 52 such that when the braking portion 51 moves to the ear portion 41 of the safety rod along the straight path 50, the braking portion 51 moves away from the straight path 50 (as shown in FIGS. 7a and 7b). The outer plain surface 62 is configured for guiding the protrusion 52 from the outer slope surface 61 such that the braking portion 51 keeps away from the straight path 50 (as shown in FIG. 7c). The inner plain surface 63 is configured for guiding the protrusion 52 to the inner slope surface 64 (as shown in FIG. 7e) when the swing stem 5 goes back to its original position along the straight path 50 from a position at which the swing stem 5 blocks the ear portion 41 of the safety rod 4. The inner slope surface 64 is capable of guiding the protrusion 52 to get across the guide plate 6 so as to reset position of the braking portion 51 (as shown in FIG. 7f).

The braking mechanism for nail guns has been discussed above, and the operation procedure of the braking mechanism will be described in detail as follows.

Referring to FIGS. 2 and 3, the braking portion 51 is away from the guide plate 6 when there are a number of (e.g. more than 10) nails 7 received in the nail track 21 of the magazine 2. In such conditions, the operator can easily push the positioning member 42 of the safety rod 4 on a surface of an object. The ear portion 41 moves upwardly along the end grooves 121, 141. As a result, the safety rod 4 drives the inner trigger to rise so as to open the trigger valve for hitting nails.

Referring to FIG. 7a, the swing stem 5 is near to the nail track base 1 and the protrusion 52 is in contact with the outer slope surface 61 when there are a few of (e.g. less than 10) nails in the nail track 21 and the nail driving track 11. The outer slope surface 61 guides the protrusion 52 such that the swing stem 5 is capable of overcome the elastic force applied by the torque spring 55. The protrusion 52 moves along the outer slope surface 61 and the outer plain surface 62 (as shown in FIGS. 7b and 7c) such that the braking portion 51 moves away from the straight path 50. In such conditions, the operator can still push the safety rod 4 to move upwardly to press the trigger valve.

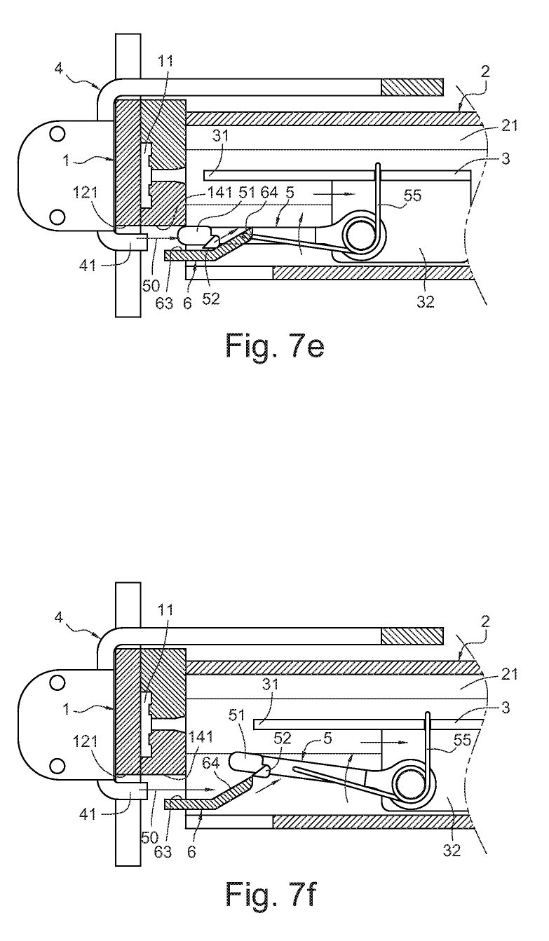

Referring to FIGS. 7c and 7d, the pressing portion 31 of the sliding member 3 enters into the nail driving track 11 and is in contact with the inner sidewall of the nail driving track 11 when the last nail 71 in the nail track 21 and the nail driving track 11 is shot into the object. The sliding member 3 and the swing stem 5 moves at a distance of the thickness of the nail 71. The protrusion 52 moves away from the outer plain surface 62 of the guide plate 6. Simultaneously, the torque spring 55 drives the swing stem to reset its position. The braking portion 51 moves back to the straight path 50 and enters into the end grooves 121, 141. As a result, the braking portion 51 blocks the ear portion 41 of the safety rod 4 (as shown in FIGS. 4 and 6). Because of the distance between the braking portion 51 and the ear portion 41 is less than the distance between the pressing portion 31 and the inner sidewall of the nail driving track 11, the braking portion 51 on the straight path 50 is capable of blocking the ear portion 41 using at least an area having a width that equals to a thickness of a nail 7. In the present embodiment, as shown FIG. 3, the braking portion 51 blocks the ear portion 41 using an area having about a width about two times than the thickness of the nails 7. The safety rod 4 can't move upwardly when the braking portion 51 blocks the ear portion 41. Therefore, the operator can't open the trigger valve to shoot.

If the operator want to reload nails 7 in the nail track, the sliding member 3 must be firstly pushed back into the nail track 21 of the magazine 2 such that there is adequate space for receiving nails 7. The sliding member 3 will bring the swing stem 5 into the nail track together (as shown in FIG. 7e). The braking portion 51 moves back to its original position along the straight path 50 from a position in the end grooves 121, 141 at which the braking portion 51 is capable of blocking the ear portion 41. The inner plain surface 63 guides the protrusion 52 to the inner slope surface 64. The inner slope surface 64 helps the swing stem 5 to overcome the elastic force applied by the torque spring 55 and moves along the inner slope surface 64. Finally, the protrusion 52 get across the guide plate 6 (as shown in FIG. 7f). Simultaneously, the torque spring 55 drives the swing stem 5 to reset its position (as shown in FIG. 7g) such that the braking portion moves back into the nail track 21 of the magazine 2. In such conditions, the operator can open the trigger valve again by pushing the safety rod to move upwardly and shoot nails 7 received in the nail track 21.

It is believed the present braking mechanism for nail guns has been fully disclosed. In the present braking mechanism, the braking portion 51 can be guided by the guide plate 6 and moves along a curved path to a position at which the braking portion 51 is capable of blocking the ear portion 41 of the safety rod 4. Finally, the braking portion 51 blocks the ear portion 41 using an area having a width that greater than a thickness of a nail. As such, the area the braking portion 51 used to block the ear portion 41 of the safety rod 4 is increased; a stability of braking action of the nail gun when there is no nail in the nail track is improved.

In addition, the protrusion 52 can also moves away from the guide plate 6 when there are a few of nails in the nail track 21. In such conditions, the distance between the protrusion 52 and the guide plate 6 or the distance between the braking portion 51 and the ear portion 41 must to be changed according to practical application. The other parts may employ similar or same structure.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A braking mechanism for a nail gun, the nail gun comprising a nail driving track, a magazine and an inner trigger for controlling a nail driving motion of the nail gun, the braking mechanism comprising;
a safety rod;
a sliding member slidably received in the magazine, the sliding member is configured for pushing nails received in the magazine into the nail driving track;
a swing stem resiliently and pivotally mounted on the sliding member, the swing stem comprising a braking portion, a straight path being defined between the safety rod and the barking portion, a protrusion being formed on the braking portion; and
a guide plate disposed at an end of the straight path, the guide plate being configured for guiding the protrusion such that the braking portion moves away from the straight path, the swing stem is capable of sliding off the guide plate as the sliding member moves to the nail driving track such that the braking portion moves back to the straight path to block the safety rod thereby braking shooting action of the nail gun.

2. The braking mechanism as claimed in claim 1, wherein a torque spring is disposed between the sliding member and the swing stem such that the swing stem is resiliently and pivotally mounted on the sliding member.

3. The braking mechanism as claimed in claim 1, wherein a distance between the braking portion and the ear portion is less than a distance between the sliding member and the nail driving track.

4. The braking mechanism as claimed in claim 1, wherein the guide plate is located at a side of the nail driving track.

5. The braking mechanism as claimed in claim 1, wherein the guide plate includes an outer slope surface configured for guiding the swing stem to move away from straight path.

6. The braking mechanism as claimed in claim 5, wherein the guide plate includes an outer plain surface extending from the outer slope surface, the outer plain surface is configured for guiding the swim stem such that the braking portion keeps away from the straight path.

7. The braking mechanism as claimed in claim 1, wherein the guide plate includes an inner slope surface configured for guiding the protrusion to get across the guide plate when the swing stem goes back to its original position from a position at which the swing stem blocks the safety rod.

8. The braking mechanism as claimed in claim 7, wherein the guide plate includes an inner plain surface extending from the inner slope surface, the inner plain surface being configured for guiding the protrusion to the inner slope surface when the swing stem goes back to its original position from a position at which the swing stem blocks the safety rod.

9. The braking mechanism as claimed in claim 1, wherein the safety rod includes an ear portion, and the straight path is defined between the ear portion and the braking portion so that the braking portion is capable of blocking the ear portion.
